(19) United States
(12) Patent Application Publication
(10) Pub. No.: US 2013/0240502 A1
(43) Pub. Date: Sep. 19, 2013

(54) RAPID THERMAL ANNEAL SYSTEM AND PROCESS

(71) Applicants: Ren-Yi CHEN, Linnei Township (TW); Ling-Sung Wang, Tainan City (TW); Cheng-Chieh Chiang, Kaohsiung City (TW)

(72) Inventors: Ren-Yi CHEN, Linnei Township (TW); Ling-Sung Wang, Tainan City (TW); Cheng-Chieh Chiang, Kaohsiung City (TW)

(73) Assignee: Taiwan Semiconductor Manufacturing Co., Ltd., Hsin-Chu (TW)

(21) Appl. No.: 13/419,946

(22) Filed: Mar. 14, 2012

(51) Int. Cl. B23K 13/08

(52) U.S. Cl. 219/482

(57) ABSTRACT

A rapid thermal anneal system and method for processing a semiconductor substrate. The system includes a chamber configured for holding a semiconductor substrate, a heating lamp array, and a process controller operably connected to the lamp array for controlling a heating cycle of the substrate. The lamp array includes a plurality of lamps positioned to heat the substrate. The controller is operable to energize or de-energize each lamp on an individual basis, and further to simultaneously energize one or more localized groups or clusters of lamps each having at least two adjacent lamps arranged for heating geographically localized regions of the substrate having special heating needs. The system is further operable to energize all lamps in the array simultaneously. The system and method provides the capability to perform customized substrate annealing.

### FIELD

The present disclosure generally relates to semiconductor processes, and more particularly to a Rapid Thermal Annealing (RTA) system and process for semiconductors.

### BACKGROUND

RTA is a form of Rapid Thermal Processing (RTP) which is commonly used in semiconductor fabrication to heat the semiconductor substrates such as silicon wafers to high temperatures (e.g. 400-1200 degrees C.) in a relatively short span of time for numerous different semiconductor processing purposes. This includes, for example, dopant activation and migration, altering and enhancing the electrical or other properties of various semiconductor films and materials, repairing damage from ion implantation, interfacial reaction of metal contacts, and others.

RTA processes may use light energy of suitable intensity and wavelength as a source of heat for radiantly heating the wafer. The wafer is generally positioned in a quartz processing reactor or chamber of a microprocessor-controlled RTA tool and an illumination system comprising one or more heating lamp or bulb arrays is activated and energized, typically for a short duration of several seconds or longer depending on the application needs, to heat the wafer substrate and semiconductor devices being formed thereon to a predetermined temperature.

Proper wafer heating is desirable to obtain electrical parameter uniformity (e.g. current, resistance, etc.) for producing good quality IC chips or dies.

An improved RTA system and method for thermally processing a wafer is desired.

### BRIEF DESCRIPTION OF THE DRAWINGS

The features of the embodiments will be described with reference to the following drawings where like elements are labeled similarly, and in which:

FIG. 1 is a schematic diagram of an exemplary RTA processing machine;

FIG. 2 is a bottom view of the heating lamp housing of FIG. 1 containing an array of lamps;

FIG. 3 is a bottom view thereof illustrating all lamps being activated and energized for a wafer heating cycle;

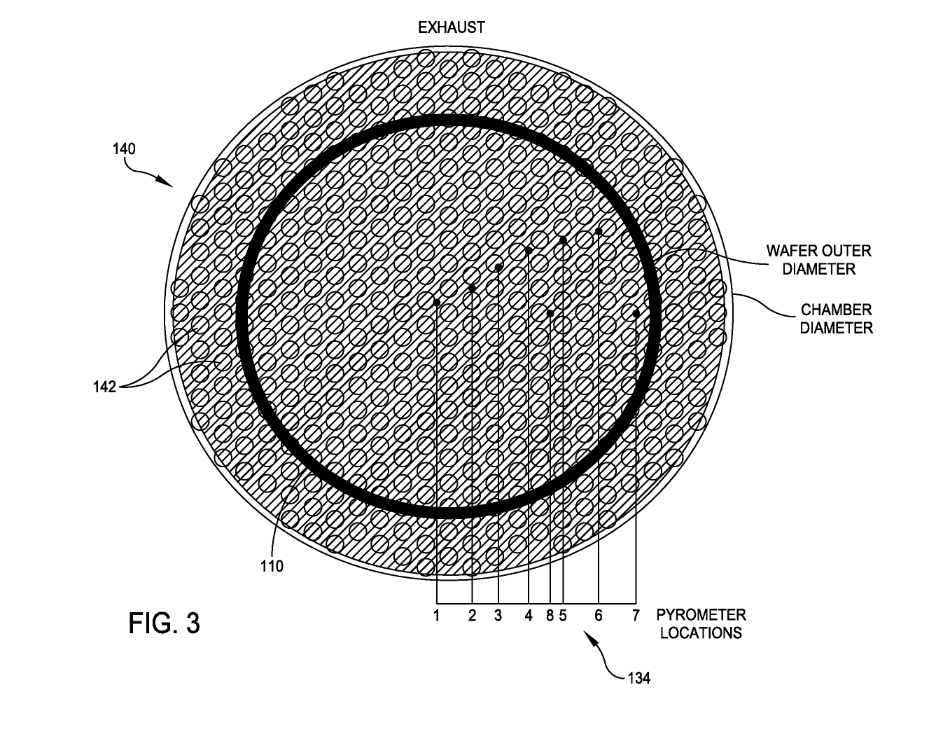

FIG. 4 is a bottom view thereof illustrating a localized cluster of lamps being activated and energized for a wafer heating cycle;

FIG. 5 illustrates a graphic display from an RTA control system showing wafer temperature measurement zones and temperature distribution profiles of the wafer generated by the control system during an RTA heating cycle; and

FIG. 6 is a flow chart of an exemplary method for performing a RTA process on a wafer.

All drawings are schematic and are not drawn to scale.

### DETAILED DESCRIPTION

This description of illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation.

Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the embodiments. Accordingly, the disclosure expressly should not be limited to such embodiments illustrating some possible non-limiting combination of features that may exist alone or in other combinations of features; the scope of the disclosure being defined by the claims appended hereto.

Uniformity in heating the entire wafer has been a general goal of RTA processes. Since portions of the wafer may not all heat uniformly due to variances in light and heat absorption properties in the semiconductor materials deposited on the wafer and/or device pattern effects from chips or dies formed on the wafer, attaining uniform wafer heating may be challenging. In addition to wafer temperature uniformity, it may be useful to provide differential or additional heating for various portions of the wafer due to asymmetrical device or chip patterns located on the wafer. Certain RTA processing chambers may also have inherent hot or cold spots due to the configuration of the machine.

Some computer processor-based control systems for RTA processes may be more focused on regulating and maintaining uniform temperature over the entire wafer during a single heating cycle as a whole. In addition, some RTA control system are designed to function best when presented with symmetric device or chip patterns on the wafer. Accordingly, there are situations where is may be useful that the heating process is more finely controlled or tuned for specific smaller regions of the wafer having asymmetrical device patterns or substrate structures in order to obtain the intended electrical properties or characteristics (e.g. device current, resistance, etc.) in the devices formed on a wafer.

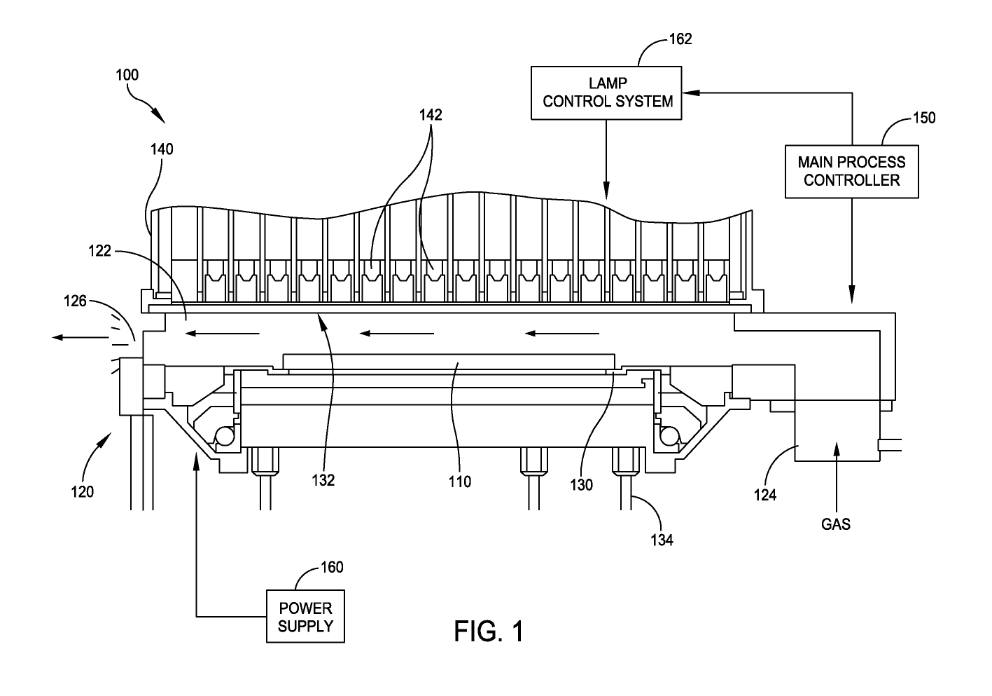

FIG. 1 depicts a block diagram of an exemplary RTA system including an RTA machine 100 for thermal processing a semiconductor substrate according to one embodiment of the present disclosure. The semiconductor substrate may be without limitation a wafer 110 containing a plurality of semiconductor devices and patterns formed on a surface thereon. Various surface regions of the semiconductor wafer 110 may have respectively different light reflectance and absorption properties based on the devices, materials, and patterns occupying different regions of the wafer.

RTA machines are commercially available from numerous companies such as Modular Process Technology Corporation of San Jose, Calif. and others.

The RTA machine 100 has a housing 120 including a thermal processing chamber 122 with a wafer holder 130 configured and dimensioned for holding wafer 110 during RTA processing. Wafer holder 130 includes an annular edge ring for supporting the edges of wafer 110. In some embodiments, the chamber 122 may be generally cylindrical in configuration. The housing 120 includes a gas inlet 124 and outlet 126 on opposing sides of and in communication with the chamber 122 for introducing and exhausting a process gas to/from the chamber. In some embodiments, an inert gas such as nitrogen (N2) or other gases that do not react with deposited films on the wafer surface may be used.

With continuing reference to FIG. 1, the RTA machine 100 includes a lamp housing 140 including an array of heating bulbs or lamps 142 for heating the wafer 110. In one embodiment, the lamp array may be positioned to face the broad bottom or top surface of the wafer 110 and therefore be within optical view of wafer so that the lamps face and shine onto the wafer 110. In one embodiment, without limitation, the lamp 142 array may be positioned above the top surface of wafer 110 as shown in FIG. 1. The array of lamps 142 may be isolated and shielded from the thermal processing chamber 122 in some embodiments by a quartz window 132.

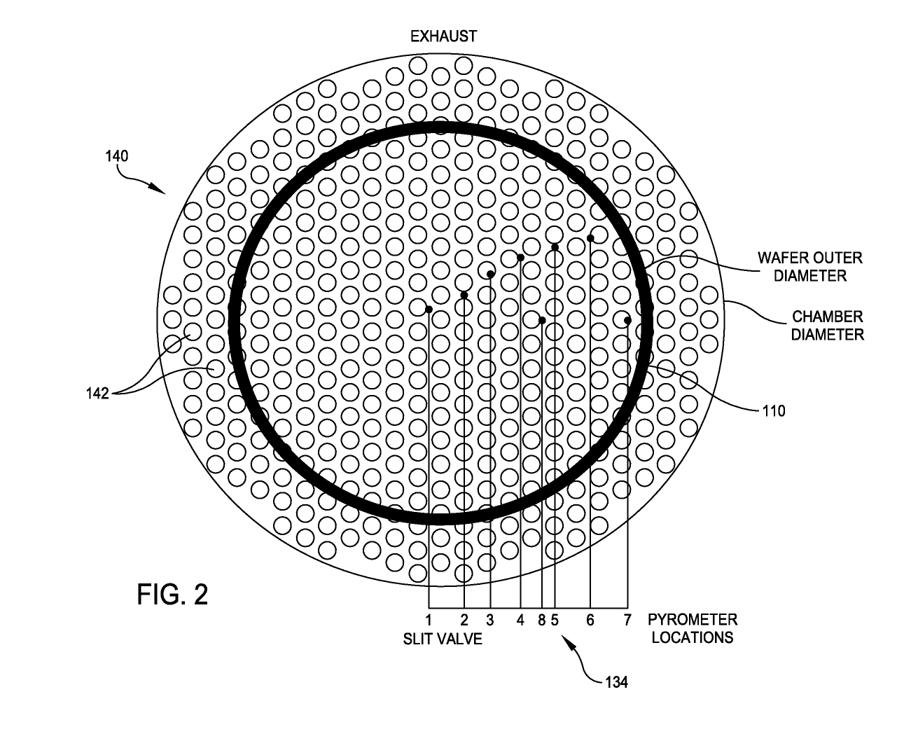

FIG. 2 shows a bottom view of the lamp housing 140 (viewed upwards from the wafer in FIG. 1) and arrangement of heating lamps 142. The wafer diameter is superimposed on the lamp array in FIG. 2 as indicated for perspective. In some representative embodiments, without limitation, the wafer 110 may be a 200 mm or 300 mm diameter wafer. The wafer 110 has a total surface area measured on the top or bottom surface (as opposed to the thin edges of the wafer) that contain unpatterned regions and patterned regions formed of various semiconductor materials and containing chips or dies (i.e. devices). Each lamp 142 in the heating lamp array will shine onto a very limited region or surface area of the wafer positioned directly below and proximate to the lamp that is less than the total surface area of the wafer 110. Each lamp 142 therefore has a corresponding illumination area on the wafer associated with the lamp that is actively heated when the lamp is energized and shines on wafer. The total number and arrangement of lamps provided are sufficient to heat the total surface area of the wafer, and in some embodiments may extend radially beyond the outer diameter of the wafer 110 as shown in FIG. 2.

Lamps 142 may be any suitable type of commercially-available heating lamps used in an RTA processing machine. In some embodiments, without limitation, lamps 142 may be of the types including halogen, tungsten halogen, xenon arc, or others. Lamps 142 produce light of a suitable wavelength and intensity to heat the wafer 110 to the desired temperatures. In some embodiments, as a representative non-limiting example, the wafer may be heated to temperatures in the range of about 200 to about 1600 degrees C. and for times ranging from about 0.001 seconds to about 1,000,000 seconds. It is well within the ambit of those skilled in the art to select an appropriate type of heating lamp based on the specific application requirement needed.

Referring to FIGS. 1 and 2, heating lamps 142 may be arranged in any suitable pattern so long as the wafer 110 may be uniformly heated. In one embodiment, the lamps 142 may form a circular array as shown. The lamps 142 may be arranged in various patterns within the array including generally vertical columns, horizontal columns, concentric rings, combinations thereof, or other suitable patterns.

Multiple fiber optic probes or the like, each being associated with a corresponding pyrometer 134 may be provided to actively sense and measure wafer temperatures at various points on the wafer during the RTA heating process. FIG. 2 shows some possible representative, but non-limiting pyrometer locations or measurement zones that may be provided in some embodiments. The pyrometers 134 are electrically connected via wiring to a main programmable RTA temperature monitoring and control system (“RTA control system” hereafter) running software to control operation of the RTA machine 100.

In one embodiment, the RTA control system includes a processor-based, programmable main process controller 150, and may further include various processing modules (with or without dedicated microprocessors), a non-transitory machine-readable storage medium operable to store instructions or program steps that is accessible to and executable by the controller 150, static and/or dynamic memory, a user interface including a visual display monitor and data entry devices such as a GUI, keyboards, etc., and other typical electronic components and appurtenances as needed for controlling the operation of the RTA machine and wafer heating process. Such RTA control systems are well known in the art, and further described for example in U.S. Pat. Nos. 6,740,196 and 5,937,142, which are incorporated herein by reference in their entireties.

Referring to FIGS. 1 and 2, RTA machine 100 further includes an electrical power supply 160 connected to an external source of power. Power supply 160 is wired to a lamp control system 162 configured and programmable for operating individual lamps 142, selected local groups or clusters of adjacent lamps, or all lamps provided in the array simultaneously at a given time (see FIG. 2 showing schematic block diagram of lamp control system). The lamp control system 162 may be controlled by operation of the main process controller 150 in some embodiments. Lamp control system 162 may include power distribution circuits and components typically associated with an RTA machine including without limitation wired circuits, power regulation devices such as on/off switches and variable current supply devices, relays, resistors, capacitors, etc. The lamp control system 162 is electrically wired to the heating lamps 142 and operable to control the power supply to the lamps.

In some embodiments, lamp control system 162 may use temperature signals received from the pyrometer 134 temperature sensing system to regulate the operation of the lamps for wafer temperature control. Process controller 150 is operable to continuously sense and monitor wafer temperatures in real time using temperature signals from the pyrometers during the wafer heating process, and to adjust heating of the wafer based on the temperatures signals received by controlling operation of the heating lamps 142 through the lamp control system 162.

In one embodiment, the architecture and programming of the lamp control system 162 is configured and operable to regulate the power supply to activate/energize or deactivate/de-energize each lamp 142 on an individual basis, a localized group or cluster of adjacent lamps, or all of the lamps in the array simultaneously. This arrangement advantageously allows heating of the entire wafer 110 by activating all lamps 142 at once (e.g. “all lamp shine”), or alternatively heating only specific geographically localized portion or regions of the wafer by simultaneously activating a localized cluster of a limited number of several adjacent lamps proximate to the wafer region intended to be heated for shot tuning (“local lamp shine”). In some embodiments, less than 20 adjacent lamps 142 and in other embodiments less than 10 adjacent lamps in close proximity to each other may comprise a lamp cluster whose lamps are simultaneously energized and activated for shot tuning.

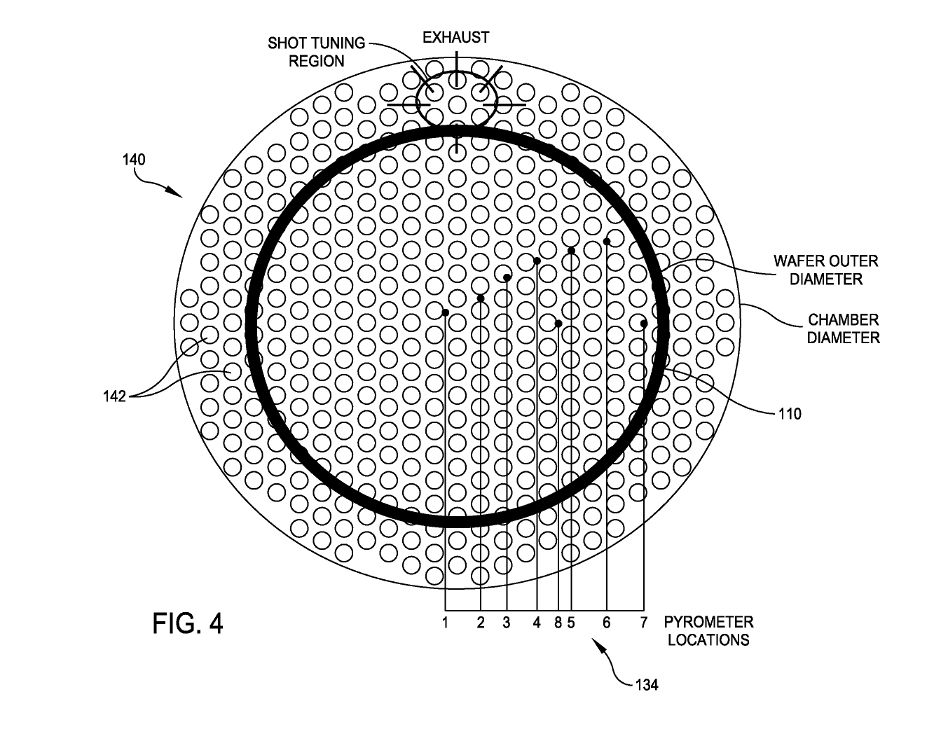

As shown in FIG. 4, the localized cluster of adjacent lamps 142 which may be energized for shot tuning may generally approximate a circular or oval shaped group of lamps in some embodiments.

In some embodiments, the shot tuning lamp cluster may form a circular or oval pattern wherein the central region of the circle or oval is filled with lamps to form an illumination or heating pattern on the wafer that is a solid region. Numerous other suitable patterns or lamp clusters to be illuminated for shot tuning other than circular or oval alone are possible by operation and/or programming of controller 150. Accordingly, embodiments of the present disclosure are not limited to any particular lamp lighting cluster pattern that may be produced. The appropriate shot tuning lamp cluster pattern will be determined by the corresponding shape of the localized region on the wafer 110 that is to receive additional heating and the number of lamps 142 and their arrangement to heat the localized region. It is well within the ambit of those skilled in the art to modify operation of the controller 150 to produce the patterns desired, either manually or automatically via the pyrometer temperature sensing system signals.

As shown in FIG. 4, it will be appreciated that the limited number of lamps 142 in the cluster to be energized need not be concentrically aligned and arranged with respect to the axial centerline of the lamp array (i.e. at the diametric center of the processing chamber 122 outer diameter marked in FIG. 4), but rather may be offset from the centerline of the lamp array in any direction as shown.

In some embodiments, more than one localized cluster of lamps 142 may be energized for shot tuning, either all simultaneously or sequentially on an individual cluster basis. The clusters of lamps 142 to be energized may be located anywhere in the lamp array depending on the corresponding regions of wafer 110 requiring additional heating. Accordingly, embodiments of the present disclosure are not limited to energizing only a single cluster of lamps for localized wafer surface heating.

Advantageously, some embodiments of a RTA control system according to the present disclosure therefore provide the ability to control the thermal budget (i.e. time that wafer is exposed to high annealing temperatures) and to increase or decrease the time that various select local regions of the wafer are exposed to heating by the lamps 142. This operating mode beneficially permits asymmetrical device patterns that may be encountered on a wafer to be readily handled and thermally processed in a precise manner to achieve the desired electrical or other properties because each region of the wafer may receive a customized dose of radiant energy from the lamp 142 array. Ultimately, this translates into higher yields and lower die rejection rates.

It is readily within the ambit of those skilled in the art to provide, configure, and program a lamp control system 162 and process controller 150 to achieve the foregoing functionality.

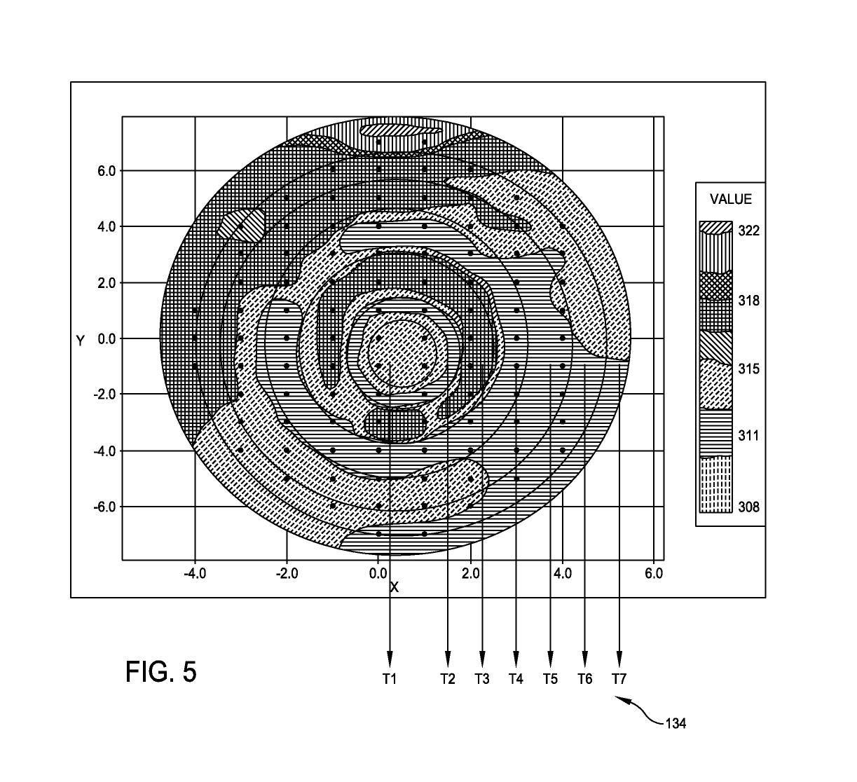

The RTA controller system may further provide an adaptive real time multi-zone heating control in some embodiments based on the temperature data signals provided by the pyrometers. In one example of an embodiment, as shown in FIG. 5, control of the lamp 142 array may be divided into a series of generally concentric ring-shaped heating zones with the temperature in each zone being measured and monitored in real time by a corresponding pyrometer 134. Main controller 150 is operable to adjust the temperature within each zone during the wafer heating cycle by controlling the lamps 142 and their associated electrical power supply as necessary according to the knowledge of those skilled in the art to maintain relatively uniform overall wafer processing temperatures within a certain range from a set point pre-programmed into the controller 150.

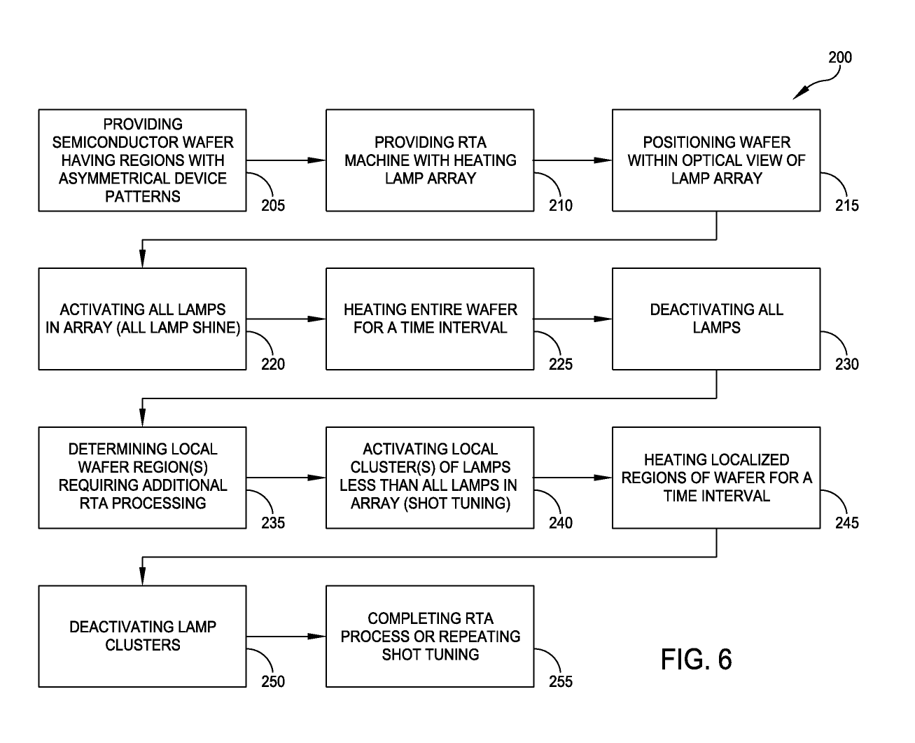

FIG. 6 shows an exemplary process or method 200 for thermally processing a semiconductor substrate such as wafer 110 via rapid thermal annealing.

In step 205, a semiconductor substrate such as wafer 110 is provided that may have asymmetrical device or material patterns formed thereon resulting in specific wafer regions having with different heat absorption properties and/or thermal processing requirements. In step 210, an RTA machine 100 is provided having a lamp array comprised of a plurality of lamps 142. In step 215, the wafer 110 is positioned within optical view of the lamp array for illumination and radiant heating by the lamps. In one non-limiting embodiment, the lamp array may be positioned above the wafer.

In step 220, an “all lamp shine” operation may first be performed to initiate a first heating or annealing cycle of the wafer 110. The controller 150 activates and energizes all lamps 142 in the array which illuminates and heats substantially the entire surface (i.e. total surface area) of the wafer 110 in step 225. The lamps 142 are illuminated for a predetermined time interval that may be pre-programmed into the RTA machine 100 via the RTA control system described herein. During this heating cycle, the wafer temperatures in each zone may be continuously monitored via the pyrometers 134 operable to sense and measure the temperature of the heat radiating from the wafer within the processing chamber 122 in real time. The lamp control system 162 is controlled by the controller 150 as necessary to automatically adjust the lamps 142 and corresponding temperature in each zone in order to maintain wafer temperature uniformity to the greatest extent possible. FIG. 5 shows an exemplary graphic display from the RTA control system indicating temperature variations in the wafer during RTA processing.

In step 230, the first heating cycle is terminated by deactivating and de-energizing all the lamps 142.

In step 235, the controller 150 determines the local areas or regions of the wafer 110 that may require additional heating (e.g. “shot tuning”) to modify the electrical properties of those portions of the wafer and/or devices in those regions. In one embodiment, the regions of the wafer that are to receive additional annealing or heating due to asymmetric device patterns or different deposited semiconductor materials may be already known to a user and pre-programmed into controller 150. This may be based on prior knowledge that certain wafer configurations, device patterns formed thereon, RTA processing chamber configurations, etc. create regions that for which additional localized shot tuning (heating) is appropriate. Accordingly, the wafer areas that required added heating by shot tuning are based on the final device map since every product has its own unique maps and may need thermal adjustment on a one by one basis. Controller 150 retrieves this information, which in some embodiments may be stored on the machine readable medium accessible to the controller. In one representative, but non-limiting example shown in FIG. 5, the terminal region of the wafer 110 adjacent to the gas exhaust or outlet port 126 is shown to have a wafer temperature that is substantially hotter than other regions of the wafer (denoted by darker temperature signature as shown).

In other embodiments, the RTA control system, through operation of controller 150 utilizing thermal mapping data of the wafer 110 from real-time temperature measurements collected by the pyrometer 134 monitoring system (see, e.g. FIG. 5), may automatically determine wafer regions to receive shot tuning (i.e. additional heating or annealing, in step 235) based on actual wafer thermal processing temperature profiles. Accordingly, it will be appreciated by one skilled in the art that wafer regions to receive additional shot tuning heating or annealing may be determined by controller 150 through either manually input or automatic analytical means as described above.

Using the foregoing results from step 235, a second heating cycle that is geographically restricted in surface area of the wafer 110 is initiated by the controller 150 activating and energizing one or more local clusters of adjacent heating lamps 142 as shown in step 240 and FIG. 4 (denoted by shot tuning region circled in this figure). Power supply to the heating lamps 142 outside of the energized lamp clusters is terminated by controller 150, thereby deactivating and de-energizing the extraneous lamps not needed for shot tuning to prevent overheating and over-processing those regions of the wafer 110 that do not require additional thermal annealing. The geographically localized regions on wafer 110 previously determined in step 235 for additional thermal processing are heated for an additional predetermined interval of time as required, in step 245 (shot tuning). Regions of wafer 110 outside of the localized heated regions may not be substantially heated by activation of the cluster of lamps. The number of lamps 142 activated and energized is less than the total number of lamps in the array. The wafer surface area corresponding to the localized wafer regions heated during the RTA shot tuning cycle by the cluster of adjacent lamps 142 represents less than the total surface area of the wafer.

In step 250, the second heating cycle is terminated by deactivating and de-energizing the cluster(s) of lamps 142. In step 255, RTA processing of the wafer is completed, or alternatively additional “shot tuning” of the same and/or other localized regions of the wafer 110 may be repeated as many times as appropriate to achieve the desired electrical or other properties.

In alternative embodiments of the method, the localized RTA “shot tuning” (i.e. localized heating of regions of the wafer) and associated steps 235, 240, 245, and 250 may be performed first before the “all lamp shine” (i.e. heating of entire wafer) steps 220, 225, and 230. In other possible embodiments, shot tuning may be performed first, followed by “all lamp shine,” and further followed by additional shot tuning. Accordingly, the RTA process described herein is not limited to any particular sequence of shot turning and all lamp shine steps.

It will be appreciated that more than one cluster of adjacent lamps 142 may be energized for an interval of time over several discrete geographically restricted regions scattered over the surface of the wafer 110 for RTA shot tuning besides just the single representative, but non-limiting region identified in FIG. 4 which illustrates just one of many possible shot tuning locations. Accordingly, in some embodiments of the method, a first, second, third, or more local clusters of adjacent lamps may be energized to heat various regions of wafer 110 for shot tuning. Each of the multiple clusters of lamps may be activated for respective intervals of time that overlap or sequentially in a staggered manner. In some embodiments, the multiple lamp clusters may all be activated simultaneously for the same interval of time, or some of the lamp clusters may be deactivated before other lamp clusters depending on the specific shot tuning (i.e. additional heating) requirements of each region to be heated. The shot tuned regions may be located anywhere on the wafer that is within optical view of the heating lamps 142. It is well within the ability of one skilled in the art to program controller 150 to activate different clusters of lamps at different or the same times according to the wafer processing.

In one embodiment, a rapid thermal anneal system for processing a semiconductor substrate includes a chamber configured for holding a semiconductor substrate having a plurality of device patterns formed thereon, a heating lamp array including a plurality of lamps positioned to radiantly heat the substrate, and a process controller operably connected to the lamp array for controlling a heating cycle of the substrate. The controller is configured and operable to energize or de-energize each individual lamp in the array for a time interval. The controller may further be operable to simultaneously energize a localized cluster of at least two adjacent lamps for heating geographically localized regions of the substrate; the number of lamps energized representing less than a total number of lamps provided in the array. In the same or other embodiments, the controller is further operable to simultaneously energize all of the lamps in the array for a time interval, either before or after energizing the localized cluster of heating lamps. The controller may further include a pyrometer-based temperature measurement system to monitor and/or control wafer temperatures during a heating cycle.

A method for thermally processing a semiconductor substrate according to some embodiments of the present disclosure includes: providing a semiconductor substrate having a plurality of device patterns formed thereon; positioning the substrate within optical view of a heating lamp array operated by a controller, the lamp array including a plurality of lamps operable to radiantly heat the substrate; energizing a first local cluster of adjacent lamps via operation of the controller, wherein the first cluster of lamps energized represents less than a total number of lamps in the array; and radiantly heating a first local region of the substrate with the first cluster of lamps for an interval of time. The method may further include a step of the controller energizing all of the lamps in the array for an interval of time. In some embodiments, the method may further include a step of the controller determining the first local region of the substrate that is to receive additional heating and energizing the first local cluster of adjacent lamps that are proximate to the first local region. In the same or other embodiments, the method may include a step of measuring the temperature of the substrate at different regions using a pyrometer temperature measurement system and the controller analyzing signals from the temperature measurement system representing temperatures of different regions of the substrate to determine the first local region of the substrate that is to receive additional heating.

In another embodiment, a method for thermally processing a semiconductor wafer in a rapid thermal annealing chamber is provided. The method includes: providing a semiconductor wafer having a asymmetrical device patterns of device patterns formed thereon; providing an RTA machine having a heating lamp array including a plurality of heating lamps and a controller configured to operate the lamp array; positioning the wafer in the RTA machine so that a top or bottom surface of the wafer to be heated is facing the lamp array; energizing all lamps in the lamp array to heat the wafer for a first interval of time; de-energizing all lamps in the lamp array; energizing a first cluster of adjacent lamps in the lamp array, wherein the first cluster of lamps represents less than a total number of lamps in the array; and radiantly heating a first local region of the substrate with the first cluster of lamps for a second interval of time. In some embodiments, the method further includes steps of de-energizing first cluster of lamps followed by re-energizing the first cluster of lamps and radiantly heating the first local region again. In the same or other embodiments, the method includes steps of energizing a second cluster of lamps different than the first cluster and radiantly heating a second local region for a third interval of time. In some embodiments, the third interval of time overlaps the second internal of time.

While the foregoing description and drawings represent exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. In addition, numerous variations in the exemplary methods and processes described herein may be made without departing from the spirit of the invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A rapid thermal anneal system for processing a semiconductor substrate, the system comprising:
a chamber configured for holding a semiconductor substrate having a plurality of device patterns formed thereon;
a heating lamp array including a plurality of lamps positioned to radiantly heat the substrate; and
a process controller operably connected to the lamp array for controlling a heating cycle of the substrate, the controller being configured and operable to energize or de-energize each individual lamp in the array for a time interval.

2. The system of claim 1, wherein the controller is operable to energize a localized cluster of at least two adjacent lamps arranged for heating a geographically localized region of the substrate, the number of lamps energized in the cluster representing less than a total number of lamps provided in the array.

3. The system of claim 2, wherein the localized cluster of adjacent lamps energized comprises less than 20 lamps.

4. The system of claim 2, wherein the controller is configured to accept external inputs for selecting the lamps comprising the localized cluster of lamps to be energized.

5. The system of claim 2, wherein the controller is configured to automatically determine the lamps comprising the localized cluster of lamps to be energized.

6. The system of claim 5, further comprising a pyrometer temperature sensing system operable to measure radiant heat from the substrate during thermal processing, the temperature sensing system sending signals to the controller and the controller using the signal to determine the lamps comprising the localized cluster of lamps to be energized.

7. The system of claim 1, wherein the controller is further operable to simultaneously energize all of the lamps in the array for a time interval.

8. The system of claim 1, wherein the controller is operably connected to a lamp control system that is operable to energize or de-energize the lamps, the lamp control system being operable to control the power supply to each lamp.

9. The system of claim 1, wherein the substrate is a semiconductor wafer having asymmetrical device patterns formed thereon.

10. A method for thermally processing a semiconductor substrate, comprising:
providing a semiconductor substrate having a plurality of device patterns formed thereon;
positioning the substrate within optical view of a heating lamp array operated by a controller, the lamp array including a plurality of lamps operable to radiantly heat the substrate;
energizing a first local cluster of adjacent lamps via operation of the controller, wherein the first cluster of lamps energized represents less than a total number of lamps in the array; and
radiantly heating a first local region of the substrate with the first cluster of lamps for an interval of time.

11. The method of claim 10, wherein the substrate is positioned in a process chamber of a rapid thermal annealing machine.

12. The method of claim 10, further comprising a step of the controller energizing all of the lamps in the array for an interval of time.

13. The method of claim 10, further comprising a step of the controller determining the first local region of the substrate requiring additional heating and energizing the first local cluster of adjacent lamps that are proximate to the first local region.

14. The method of claim 13, further comprising a step of measuring the temperature of the substrate at different regions using a pyrometer temperature measurement system and the controller analyzing signals from the temperature measurement system representing temperatures of different regions of the substrate to determine the first local region of the substrate requiring additional heating.

15. The method of claim 10, further comprising:
energizing a second local cluster of adjacent lamps via operation of the controller, wherein the second local cluster of lamps energized represents less than a total number of lamps in the array; and
radiantly heating a second local region of the substrate with the second cluster of lamps for an interval of time.

16. The method of claim 15, wherein the second cluster of lamps is energized simultaneously with the first cluster of lamps.

17. A method for thermally processing a semiconductor wafer in a rapid thermal annealing (RTA) chamber, the method comprising:
providing a semiconductor wafer having a asymmetrical device patterns of device patterns formed thereon;
providing an RTA machine having a heating lamp array including a plurality of heating lamps and a controller configured to operate the lamp array;
positioning the wafer in the RTA machine so that a top or bottom surface of the wafer to be heated is facing the lamp array;
energizing all lamps in the lamp array to heat the wafer for a first interval of time;
de-energizing all lamps in the lamp array;
energizing a first cluster of adjacent lamps in the lamp array, wherein the first cluster of lamps represents less than a total number of lamps in the array; and
radiantly heating a first local region of the substrate with the first cluster of lamps for a second interval of time.

18. The method of claim 17, further comprising steps of de-energizing first cluster of lamps followed by re-energizing the first cluster of lamps and radiantly heating the first local region again.

19. The method of claim 17, further comprising steps of energizing a second cluster of lamps different than the first cluster and radiantly heating a second local region for a third interval of time.

20. The method of claim 19, wherein the third interval of time overlaps the second internal of time.
